(19) United States
(12) Patent Application Publication
(10) Pub. No.: US 2023/0311442 A1
(43) Pub. Date: Oct. 5, 2023

(54) DUST SOLIDIFICATION APPARATUS

(71) Applicant: SINTOKOGIO, LTD., Nagoya-shi (JP)

(72) Inventors: Yoshihiko OGI, Nagoya-shi (JP); Shintaro NISHIKAWA, Nagoya-shi (JP); Noriaki MASAKI, Nagoya-shi (JP); Koh SAITO, Nagoya-shi (JP)

(73) Assignee: SINTOKOGIO, LTD., Nagoya-shi (JP)

(21) Appl. No.: 18/096,216

(22) Filed: Jan. 12, 2023

(30) Foreign Application Priority Data
Mar. 31, 2022 (JP) 2022-060041

(51) Int. Cl. B30B 11/02; B30B 15/30; B08B 15/00

(52) U.S. Cl. CPC B30B 11/02; B30B 15/302; B08B 15/00

(57) ABSTRACT

A dust solidification apparatus including a storage tank for storing dust; a forming member that is disposed at a lower portion of the storage tank, the forming member being provided with a forming hole to allow the dust in the storage tank to flow in; and a first rod and a second rod that are opposed to each other, wherein the first rod and the second rod are driven to reciprocate by advancing into and withdrawing from the forming hole, and advance into the forming hole to compress the dust in the forming hole, wherein the first rod includes a rod tip and a rod base. The axially vertical cross-section of the rod tip of the first rod is larger than the axially vertical cross-section of the rod base of the first rod and is made smaller than the axially vertical cross-section of the forming hole.

### TECHNICAL FIELD

The present disclosure relates to a dust solidification apparatus.

### CROSS-REFERENCE TO RELATED APPLICATION

This application claims the benefit of priority from Japanese Patent Application No. 2022-060041, filed on Mar. 31, 2022, the entire contents of which are incorporated herein by reference.

### BACKGROUND

Fumes generated during laser processing, plasma processing, and welding, etc. of metallic materials and the like can cause serious health hazards if inhaled by workers. Therefore, in order to keep the working environment clean, a dust collecting device is operated to remove the dust from the working environment. In addition, the dust collected in the dust collecting device is in a state of low bulk density, and since it is difficult to handle dust in this state, the dust is compressed, solidified, and processed into a state that is easy to handle (e.g., pellet form). Dust that has been processed into this easy-to-handle state becomes reusable by carrying out a treatment such as remelting.

Patent Document 1 discloses a dust solidification apparatus that prevents dust from scattering and also performs solidification of dust with a simple structure. This dust solidification apparatus includes an apparatus body, a hopper for storing dust, the hopper being provided on the apparatus body, a forming member provided within the hopper, the forming member having a forming hole, and a pressurizing rod that is configured to freely advance and withdraw with respect to the forming hole. In this dust solidification apparatus, the pressurizing rod is advanced into the forming hole to solidify the dust loaded therein, thereby forming a solidified substance. In addition, the openings of the forming hole are open within the hopper.

### CITATION LIST

### Patent Literature

Patent Document 1: Japanese Patent Application Publication 2021-084052 A

### SUMMARY OF INVENTION

### Technical Problem

However, in the apparatus described in Patent Document 1, the dust solidification operation causes the dust to adhere to the inner wall of the forming hole, and by repeating this dust solidification operation, the dust adhered to the inner wall of the forming hole accumulates and sticks to the inner wall. Therefore, the sliding resistance (frictional resistance) between the rod and the inner wall of the forming hole increases, thereby increasing the force required to drive the rod. As a result thereof, an operational abnormality is more likely to occur in the dust solidification apparatus, and therefore there is room for improvement. The present disclosure was made in view of the above, and has a purpose of providing a dust solidification apparatus in which the sliding resistance of rods is suppressed.

### Solution to Problem

One aspect of the present disclosure that solves the above problem and achieves the purpose is a dust solidification apparatus. The dust solidification apparatus includes a storage tank for storing dust, a forming member that is disposed at a lower portion of the storage tank, the forming member being provided with a forming hole to allow the dust in the storage tank to flow in, and a first rod and a second rod that are opposed to each other, wherein the first rod and the second rod are driven to reciprocate by advancing into and withdrawing from the forming hole, and advance into the forming hole to compress the dust in the forming hole. The first rod includes a rod tip and a rod base. The axially vertical cross-section of the rod tip of the first rod is larger than the axially vertical cross-section of the rod base of the first rod and is smaller than the axially vertical cross-section of the forming hole. The rods are each positioned on the axis of the forming hole, and an axially vertical cross-section refers to a section that is perpendicular to the longitudinal direction of the forming hole. An axial direction is the longitudinal direction of the rods and is generally aligned with the longitudinal direction of the forming hole.

According to the dust solidification apparatus with the configuration described above, by enlarging the rod tip of the first rod with respect to the rod base, the rod tip of the first rod grinds the dust adhered to the inner wall of the forming hole, and the sliding area of the first rod and the inner wall of the forming hole is reduced, thereby making it possible to suppress the sliding resistance of the first rod. As a result thereof, the force for driving the first rod is suppressed, and an occurrence of an operation abnormality in the dust solidification apparatus can be suppressed.

In one embodiment, the second rod is shaped similar to the first rod. That is, the second rod includes a rod tip and a rod base, and the axially vertical cross-section of the rod tip of the second rod is larger than the axially vertical cross-section of the rod base of the second rod and is smaller than the axially vertical cross-section of the forming hole. By enlarging the rod tip of the second rod with respect to the rod base, the rod tip of the second rod grinds the dust adhered to the inner wall of the forming hole, and the sliding area of the second rod and the inner wall of the forming hole is reduced, thereby making it possible to suppress the sliding resistance of the second rod.

In one embodiment, the rod tips of the first rod and/or the second rod are detachable with respect to the rod bases. Consequently, worn rod tips can be replaced. Thus, the maintainability can be improved.

In one embodiment, grooves are provided on the outer perimeters of the rod tips of the first rod and/or the second rod. Consequently, the dust adhering to the inner wall of the forming hole is ground, and the ground dust is discharged from the groove, so it is possible to effectively prevent the dust from sticking to the inner wall of the forming hole.

### Effects of Invention

According to at least one embodiment of the present disclosure, it is possible to provide a dust solidification apparatus in which the sliding resistance of rods is suppressed.

### BRIEF DESCRIPTION OF DRAWINGS

FIG. 1 is a diagram illustrating a schematic configuration of a dust solidification apparatus according to an embodiment.

FIG. 2 is a perspective view illustrating the vicinity of rod tips of a pressurizing rod and a closing rod applied to the dust solidification apparatus according to the embodiment.

FIG. 3 is a diagram illustrating a side surface of a pressurizing rod onto which a pressurizing rod tip, which is a ring-shaped member, is fit.

FIG. 4 is a diagram illustrating a side surface of a pressurizing rod onto which a pressurizing rod tip, which is a cap-shaped member, is fit.

FIG. 5 is a cross-sectional schematic diagram illustrating the inside of a forming hole during a dust solidification operation of the dust solidification apparatus according to the embodiment.

FIG. 6 is a schematic diagram illustrating the diameter and the thickness of a rod tip.

FIG. 7 is an axially vertical cross-sectional view illustrating the relationship between the diameters of the rod tip, the rod base, and the forming hole.

FIG. 8 is a schematic view illustrating a pressurizing rod tip having an axially vertical cross-section that is regular hexagon in shape.

FIG. 9 is an axially vertical cross-sectional view illustrating a state in which a pressurizing rod tip having an axially vertical cross-section that is circular in shape has advanced into a forming hole having an axially vertical cross-section that is regular hexagon in shape.

FIG. 10 is an axially vertical cross-sectional view illustrating a state in which a pressurizing rod tip having an axially vertical cross-section that is regular hexagon in shape has advanced into a forming hole having an axially vertical cross-section that is circular in shape.

FIG. 11 is a perspective view illustrating a rod tip member which is a modified example of the pressurizing rod and/or the closing rod applied to the dust solidification apparatus according to the embodiment.

### DESCRIPTION OF EMBODIMENTS

Hereinafter, some embodiments of the present disclosure will be described with reference to the drawings. However, the dimensions, the materials, the shapes, the relative arrangements, etc. of the components described as embodiments or illustrated in the drawings are not intended to limit the scope of the present invention, and are merely illustrative examples. The terms “upper” and “lower” are based on the illustrated states and are only for convenience.

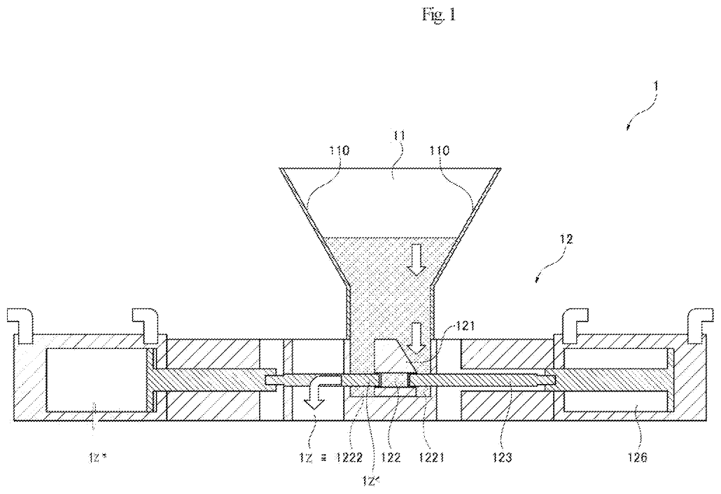

FIG. 1 is a diagram illustrating a schematic configuration of a dust solidification apparatus 1 according to the present embodiment. The dust solidification apparatus 1 illustrated in FIG. 1 includes a storage tank (e.g., a hopper) 11 and a dust solidifier 12 that is disposed at a lower portion of the storage tank 11.

The storage tank 11 includes inclined side walls 110 and stores dust that falls from above.

The dust solidifier 12 includes a forming member 121 provided with a forming hole 122, a pressurizing rod 123 which is a first rod, a closing rod 124 which is a second rod, a discharge hole 125 through which formed solidified substances are discharged, a pressurizing cylinder 126 that drives the pressurizing rod 123, and a closing cylinder 127 that drives the closing rod 124. The forming hole 122 is a through hole disposed between the pressurizing rod 123 and the closing rod 124 and into which the pressurizing rod 123 and the closing rod 124 can be inserted.

The forming member 121 is a member to which the forming hole 122 is provided such that the dust in the lower portion in the storage tank 11 flows in. The forming hole 122 is a through hole disposed between the pressurizing rod 123 and the closing rod 124, through which a first opening 1221 and a second opening 1222 pass, and through which the pressurizing rod 123 and the closing rod 124 can be inserted. Here, the axially vertical cross-section (a section that is perpendicular to the longitudinal direction) of the forming hole 122 is circular.

The pressurizing rod 123 is a first rod that has an axially vertical cross-section that is circular in shape, and is capable of reciprocating by advancing into and withdrawing from the forming hole 122 through the first opening 1221. The closing rod 124 is a second rod that has an axially vertical cross-section that is circular in shape, and is capable of reciprocating by advancing into and withdrawing from the forming hole 122 through the second opening 1222, and the closing rod 124 is a rod that, while forming a solidified substance, advances into the forming hole 122 to a certain dimension, stops, and remains stationary. The pressurizing rod 123 is driven to reciprocate so as to advance into and withdraw from the forming hole 122, and when the pressurizing rod 12 withdraws from the forming hole 122, the dust in the lower portion of the storage tank 11 flows into the forming hole 122. The pressurizing rod 123 advances into the forming hole 122 and pushes the dust that has flowed into the forming hole 122. In the forming hole 122, the dust is pressed, compacted, and compressed by the pressurizing surface of the pressurizing rod 123 and the pressurizing surface of the closing rod 124 that are opposed to each other, thereby forming a pellet-shaped solidified substance.

The discharge hole 125 is a hole for dropping and discharging the formed solidified substance. The formed solidified substance is sandwiched between the pressurizing rod 123 and the closing rod 124, conveyed to the discharge hole 125, and then discharged. The pressurizing cylinder 126 is a driving source that reciprocates the pressurizing rod 123. The closing cylinder 127 is a driving source that reciprocates the closing rod 124.

Note that the present disclosure is not limited to the configuration illustrated in FIG. 1, and the positions of the pressurizing rod 123 and the pressurizing cylinder 126 may be replaced with the positions of the closing rod 124 and the closing cylinder 127.

The operations of the dust solidification apparatus 1 illustrated in FIG. 1 are controlled by a controller, which is not shown. Specifically, the controller, which is not shown, controls the operations of the pressurizing rod 123 and the closing rod 124 by outputting an operation command to the pressurizing cylinder 126 and the closing cylinder 127.

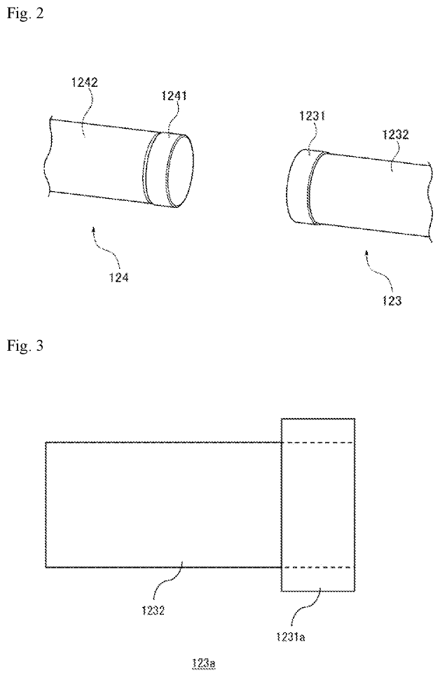

FIG. 2 is a perspective view illustrating the vicinity of rod tips of the pressurizing rod 123 and the closing rod 124 applied to the dust solidification apparatus 1 according to the present embodiment. The pressurizing rod 123 includes a pressurizing rod tip 1231 and a pressurizing rod base 1232. The closing rod 124 includes a closing rod tip 1241 and a closing rod base 1242.

The axially vertical cross-section of the pressurizing rod tip 1231 of the pressurizing rod 123 is larger than the axially vertical cross-section of the pressurizing rod base 1232 of the pressurizing rod 123 and is smaller than the axially vertical cross-section of the forming hole 122. Here, the axially vertical cross-sections of the pressurizing rod tip 1231 and the pressurizing rod base 1232 are circular. The axially vertical cross-section of the closing rod tip 1241 of the closing rod 124 is larger than the axially vertical cross-section of the closing rod base 1242 of the closing rod 124 and is smaller than the axially vertical cross-section of the forming hole 122. The axially vertical cross-sections of the closing rod tip 1241 and the closing rod base 1242 are circular.

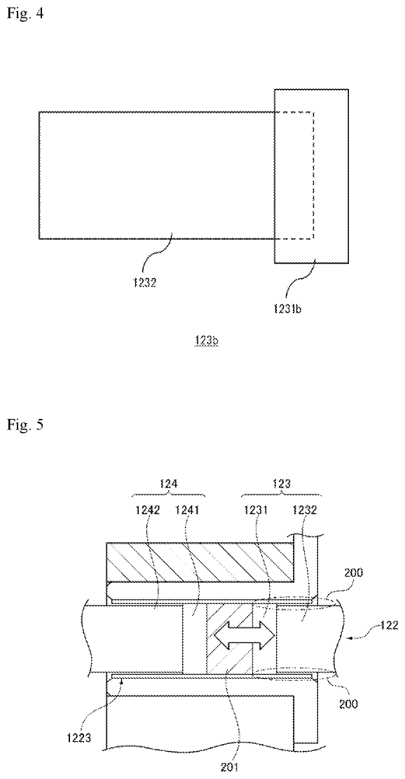

The pressurizing rod tip 1231 may be integrally formed with the pressurizing rod base 1232 or may be configured to be detachable with respect to the pressurizing rod base 1232. The closing rod tip 1241 may be integrally formed with the closing rod base 1242 or may be configured to be detachable with respect to the closing rod base 1242. When the rod tips are detachable with respect to the rod bases, worn rod tips can be replaceable. Thus, the maintainability can be improved. Here, the pressurizing rod 123 repeats advancing and withdrawing more frequently than the closing rod 124 during a dust solidification operation, so it is particularly preferable that the pressurizing rod tip 1231 of the pressurizing rod 123 is detachable with respect to the pressurizing rod base 1232. Note that there are screw threads provided on sides, of the pressurizing rod tip 1231 and the closing rod tip 1241, that are opposite to the sides that come into contact with the dust, and detachable configurations can be realized by having these screw threads be screwed onto the rod bases. Alternatively, the pressurizing rod tip 1231 and the closing rod tip 1241 can realize detachable configurations by means of a ring-shaped member, such as an O-ring, or a cap-shaped member that is fitted onto the rod base 1232. FIG. 3 is a diagram illustrating the side surface of a pressurizing rod 123a onto which a pressurizing rod tip 1231a, which is a ring-shaped member, is fit, and FIG. 4 is a diagram illustrating the side surface of a pressurizing rod 123b onto which a pressurizing rod tip 1231b, which is a cap-shaped member, is fit. Note that although FIG. 3 and FIG. 4 illustrate the pressurizing rods 123a,123b, closing rods can also have a similar configuration.

Furthermore, the pressurizing rod tip 1231 and the closing rod tip 1241 are preferably made of materials having high wear resistance. As a result thereof, the wear of the pressurizing rod tip 1231 and the closing rod tip 1241 can be suppressed.

FIG. 5 is a cross-sectional schematic diagram illustrating the inside of the forming hole 122 during a dust solidification operation of the dust solidification apparatus 1 according to the present embodiment. In FIG. 5, a dust solidification operation is performed by the pressurizing rod 123 including the pressurizing rod tip 1231 and the pressurizing rod base 1232 advancing into and withdrawing from the forming hole 122 in which the closing rod 124 including the closing rod tip 1241 and the closing rod base 1242 is stationary, and the pressurizing rod 123 reciprocating.

The pressurizing rod tip 1231 of the pressurizing rod 123 and the closing rod tip 1241 of the closing rod 124 compress the dust to form a solidified substance 201. As shown in FIG. 5, enlarging the pressurizing rod tip 1231 of the pressurizing rod 123 with respect to the pressurizing rod base 1232 makes it possible to grind the dust 200 adhered to the inner wall 1223 of the forming hole 122 by means of the pressurizing rod tip 1231 of the pressurizing rod 123 and to also reduce the sliding area of the pressurizing rod 123 and the inner wall 1223 of the forming hole 122. Thus, the sliding resistance of the pressurizing rod 123 can be reduced. As a result thereof, the force for driving the pressurizing rod 123 can be suppressed, thereby making it possible to suppress the occurrence of an operation abnormality in the dust solidification apparatus 1 and also to downsize the dust solidification apparatus 1 and save energy.

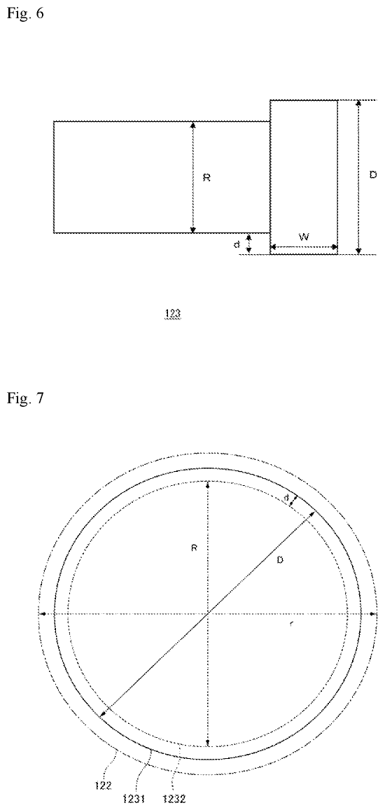

FIG. 6 is a schematic diagram illustrating the diameter D and the thickness w of the rod tip. FIG. 6 shows the diameter R of the pressurizing rod base 1232, the diameter D of the pressurizing rod tip 1231, the thickness w of the pressurizing rod tip 1231, and the diameter difference d between the pressurizing rod base 1232 and the pressurizing rod tip 1231. FIG. 7 is an axially vertical cross-sectional view illustrating the relationship between the diameters of the rod tip, the rod base, and the forming hole. FIG. 7 shows the diameter R of the pressurizing rod base 1232, the diameter D of the pressurizing rod tip 1231, the diameter r of the forming hole 122, and the diameter difference d between the pressurizing rod base 1232 and the pressurizing rod tip 1231. Note that although FIG. 6 and FIG. 7 illustrate the pressurizing rod 123, the closing rod 124 can also have a similar configuration. The diameters D of the pressurizing rod tip 1231 and the closing rod tip 1241 are larger than the diameters R of the pressurizing rod base 1232 and the closing rod base 1242 and are made smaller than the diameter r of the forming hole 122 so as to enable reciprocating movement by advancing into and withdrawing from the forming hole 122. In particular, the diameters D of the pressurizing rod tip 1231 and the closing rod tip 1241 are preferably larger than the diameters R of the pressurizing rod base 1232 and the closing rod base 1242 by a range of 0.2 mm or more to 0.4 mm or less (i.e., 0.2 mm≤d≤0.4 mm). As one example, if the diameters R of the pressurizing rod base 1232 and the closing rod base 1242 are 15 mm, the diameters D of the pressurizing rod tip 1231 and the closing rod tip 1241 may be 15.2 mm≤D≤15.4 mm.

In addition, it is preferable to set the thicknesses w of the pressurizing rod tip 1231 and the closing rod tip 1241 to the smallest thickness capable of bearing load. The thicknesses w of the pressurizing rod tip 1231 and the closing rod tip 1241 are the distances from each pressurizing surface to the rod bases. When the thicknesses w of the pressurizing rod tip 1231 and the closing rod tip 1241 are reduced, the sliding areas of the inner wall 1223 of the forming hole 122 and the pressurizing rod 123 and the closing rod 124 are smaller, thereby suppressing the sliding resistance. As one example, the thicknesses w of the pressurizing rod tip 1231 and the closing rod tip 1241 may be 0.1 mm w 10.0 mm. Note that the rods are each positioned on the axis of the forming hole, and an axially vertical cross-section refers to a section that is perpendicular to the longitudinal direction of the forming hole. An axial direction is the longitudinal direction of the rods and is generally aligned with the longitudinal direction of the forming hole.

As described above, according to the dust solidification apparatus 1 of the present embodiment, enlarging the pressurizing rod tip 1231 of the pressurizing rod 123 with respect to the pressurizing rod base 1232 makes it possible to grind the dust adhered to the inner wall 1223 of the forming hole 122 by means of the pressurizing rod tip 1231 of the pressurizing rod 123 and to also reduce the sliding area of the pressurizing rod 123 and the inner wall 1223 of the forming hole 122, thereby suppressing the sliding resistance of the pressurizing rod 123. As a result thereof, the occurrence of an operation abnormality in the dust solidification apparatus 1 can be suppressed.

In addition, when the closing rod 124 has a similar shape to the pressurizing rod 123, and the closing rod tip 1241 of the closing rod 124 is enlarged with respect to the closing rod base 1242, this makes it possible to grind the dust adhering to the inner wall 1223 of the forming hole 122 by means of the closing rod tip 1241 of the closing rod 124 and to also reduce the sliding area of the closing rod 124 and the inner wall 1223 of the forming hole 122, thereby suppressing the sliding resistance of the closing rod 124.

### Modified Example 1

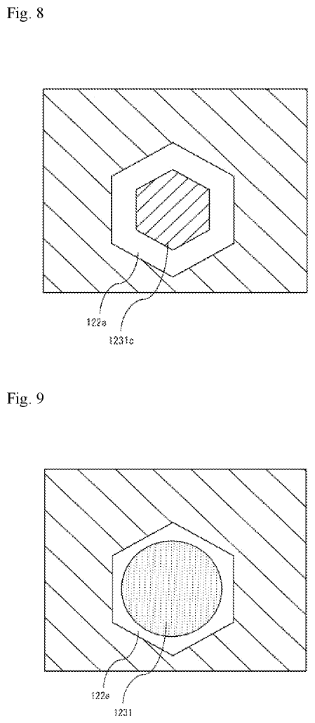

The present embodiment describes a case in which the axially vertical cross-sections of the forming hole 122, the pressurizing rod tip 1231, and the closing rod tip 1241 are circular, but the present invention is not limited thereby. As a modified example of the present embodiment, the axially vertical cross-sections of the forming hole 122, the pressurizing rod tip 1231, and the closing rod tip 1241 may be polygonal, such as a regular hexagon. FIG. 8 is a schematic view illustrating a pressurizing rod tip 1231c having an axially vertical cross-section that is a regular hexagon in shape. In FIG. 8, the pressurizing rod tip 1231c is advanced into a forming hole 122a having an axially vertical cross-section that is a regular hexagon in shape. Note that although FIG. 8 illustrates the pressurizing rod of the pressurizing rod tip 1231c, the closing rod 124 may also have a similar shape. The axially vertical cross-sections of the pressurizing rod base 1232 and the closing rod base 1242 may also be polygonal, such as a regular hexagon.

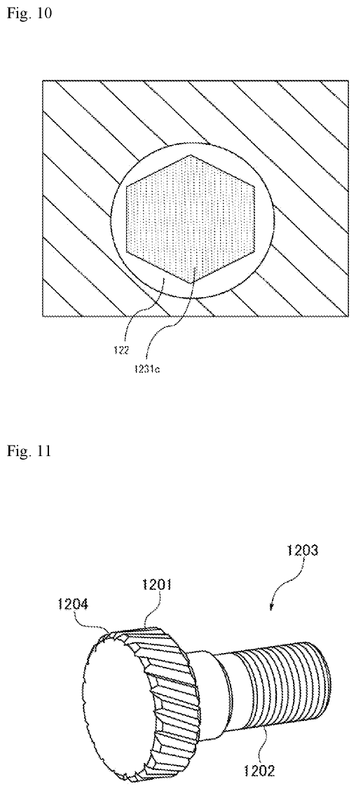

In addition, the axially vertical cross-section of the rod tip and the axially vertical cross-section of the rod base do not have to align with each other. FIG. 9 is an axially vertical cross-sectional view illustrating a state in which the pressurizing rod tip 1231 having an axially vertical cross-section that is circular in shape is advanced into the forming hole 122a having an axially vertical cross-section that is a regular hexagon in shape, and FIG. 10 is an axially vertical cross-sectional view illustrating a state in which the pressurizing rod tip 1231c having an axially vertical cross-section that is a regular hexagon in shape is advanced into the forming hole 122 having an axially vertical cross-section that is circular in shape.

### Modified Example 2

As a modified example of the present embodiment, grooves may be provided on the outer perimeters of the pressurizing rod tip 1231 and/or the closing rod tip 1241.

FIG. 11 is a perspective view illustrating a rod tip member 1203, which is a modified example of the pressurizing rod 123 and/or the closing rod 124 applied to the dust solidification apparatus 1 according to the present embodiment. FIG. 11 illustrates the rod tip member 1203 including a rod tip 1201 and a rod mounting part 1202 each having grooves provided on the outer perimeters thereof. In the rod tip member 1203 illustrated in FIG. 11, the rod tip 1201 is provided with grooves 1204 that are formed obliquely with respect to the direction of the thickness of the rod tip. The grooves 1204 provided in this manner grind the dust adhering to the inner wall 1223 of the forming hole 122, and the ground dust is discharged by the grooves 1204, thereby making it is possible to effectively prevent the dust from sticking to the inner wall 1223 of the forming hole 122. However, the shapes of the grooves 1204 are not limited to those illustrated in FIG. 11, and are not limited to a specific shape as long as the dust adhering to the inner wall 1223 of the forming hole 122 can be ground and the ground dust can be discharged. For example, groove machining or knurling can form a flat pattern or a crisscross pattern.

Note that the rod tip member 1203 illustrated in FIG. 11 is configured to be detachable with respect to a rod base which is not shown, but the present invention is not limited thereto, and in an embodiment in which a rod tip is integrally formed with a rod base, grooves may be provided on the outer perimeter of the rod tip.

### Summary of Embodiments

According to the dust solidification apparatus 1, enlarging the pressurizing rod tip 1231 of the pressurizing rod 123 with respect to the pressurizing rod base 1232 makes it possible to grind the dust 200 adhered to the inner wall 1223 of the forming hole 122 by means of the pressurizing rod tip 1231 of the pressurizing rod 123 and to also reduce the sliding area of the pressurizing rod 123 and the inner wall 1223 of the forming hole 122, thereby suppressing the sliding resistance of the pressurizing rod. As a result thereof, the force for driving the first rod is suppressed, and the occurrence of an operation abnormality in the dust solidification apparatus can be suppressed. In addition, when the closing rod 124 has a similar shape to the pressurizing rod 123, and the closing rod tip 1241 of the closing rod 124 is enlarged with respect to the closing rod base 1242, this makes it possible to suppress the sliding resistance as in the case of the pressurizing rod and to suppress the occurrence of an operation abnormality in the dust solidification apparatus.

The pressurizing rod tip 1231 of the pressurizing rod 123 and/or the closing rod tip 1241 of the closing rod 124 is each detachable with respect to the pressurizing rod base 1232 and/or the closing rod base 1242, so a worn pressurizing rod tip 1231 and/or the closing rod tip 1241 can be replaced.

Since grooves are provided on the outer perimeter of the pressurizing rod tip 1231 of the pressurizing rod 123 and/or the closing rod tip 1241 of the closing rod 124, the dust adhering to the inner wall 1223 of the forming hole 122 is ground, and the ground dust is discharged by the grooves 1204, thereby making it is possible to effectively prevent the dust from sticking to the inner wall 1223 of the forming hole 122.

1. A dust solidification apparatus comprising:
a storage tank for storing dust;
a forming member that is disposed at a lower portion of the storage tank, the forming member being provided with a forming hole to allow the dust in the storage tank to flow in; and
a first rod and a second rod that are opposed to each other, wherein the first rod and the second rod are driven to reciprocate by advancing into and withdrawing from the forming hole, and advance into the forming hole to compress the dust in the forming hole,
wherein the first rod comprises a rod tip and a rod base, and
an axially vertical cross-section of the rod tip of the first rod is larger than an axially vertical cross-section of the rod base of the first rod and is smaller than an axially vertical cross-section of the forming hole.

2. The dust solidification apparatus according to claim 1,
wherein the second rod comprises a rod tip and a rod base, and
an axially vertical cross-section of the rod tip of the second rod is larger than an axially vertical cross-section of the rod base of the second rod and is smaller than the axially vertical cross-section of the forming hole.

3. The dust solidification apparatus according to claim 1,
wherein the rod tip is detachable with respect to the rod base.

4. The dust solidification apparatus according to claim 2,
wherein the rod tip is detachable with respect to the rod base.

5. The dust solidification apparatus according to claim 1,
wherein grooves are provided on the outer perimeter of the rod tip.

6. The dust solidification apparatus according to claim 2,
wherein grooves are provided on the outer perimeter of the rod tip.

7. The dust solidification apparatus according to claim 3,
wherein grooves are provided on the outer perimeter of the rod tip.

8. The dust solidification apparatus according to claim 4,
wherein grooves are provided on the outer perimeter of the rod tip.
